(19) United States
(12) Patent Application Publication
(10) Pub. No.: US 2012/0066230 A1
(43) Pub. Date: Mar. 15, 2012

(54) Object sharing and search system

(76) Inventor: Chen-Yu Sheu, Irvine, CA (US)

(21) Appl. No.: 12/807,822

(22) Filed: Sep. 15, 2010

(51) Int. Cl. G06F 17/30

(52) U.S. Cl. 707/748; 707/755; 707/736; 707/E17.075; 707/E17.062

(57) ABSTRACT

This invention is related to an object sharing and search system (OS3) that allows users to create and share computational content of any sort in a multi-user computing environment. It considers user, domain and document as three basic and interacting classes of objects, and allows users to create domain hierarchies, to create objects within a domain, to specify the accessibility of an object in a domain, etc., and it controls the access of an object by another object in a domain. It also allows users to search objects in a domain and recommend the ranking for a search.

### BACKGROUND OF THE INVENTION

1. Field of the Invention

This invention is related to an Object Sharing and Search System (OSSS, or OS3) that allows users to create and share computational content of any sort in a multi-user computing environment (e.g., Internet, intranet, cell phone network, client-server). It also allows users to affect the ranking of a search for objects.

2. Description of the Related Art

While existing web publishing systems (e.g., traditional web publishing, blogs and social networking) have focused on users and read-only content (notes/web pages), this invention provides an object sharing and search system that unifies them into an object-oriented architecture to include computational content of all sorts. It further elaborates the architecture with access control and a third type of objects, namely “domain”, in addition to “document” and “user”. The three types of objects interact with each other. A domain is different from a simple folder or directory as it is an object that may contain other objects (documents, domains and users).

Specifically it allows users to create domain hierarchies, to create an object in a domain, to specify the accessibility of an object by another object in a domain, to search objects in a domain, and to control the access of an object by another object in a domain.

In this invention the term “user” refers to a registered user unless otherwise specified.

The invention also allows a user to explicitly annotate an object. It also allows a user to recommend an object (document, domain or user) for a search so that the recommended object may be ranked higher when the same, or a similar, query is posted by the same user or other registered and un-registered users. This is different from traditional search systems where users cannot affect the rankings explicitly.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

### DETAILED DESCRIPTION OF THE PREFERRED EMBODIMENT

The following subsections describe an object sharing and search system that embodies various inventive features. The various inventive features can be implemented differently than described herein. Thus, the following description is intended only to illustrate, and not limit, the scope of the present invention.

### Architecture of OS3

The Object Sharing and Search System (OS3) considers user, domain and document as three basic and interacting classes of objects in a multi-user environment. It allows a user to create an object within a domain, specify its accessibility to other objects in a domain, and to recommend an object for search in a domain.

The architecture of the OS3 system is shown in FIG. 1:

1. Query User Interface 110, an interface through which a registered or un-registered user can post a query in natural language, a structured natural language or a set of keywords.
2. Object Management Module 120, through which a user can create an object in a domain and specify its accessibility to other objects in the domain.
3. Access Control Module 130, through which OS3 decides if an object can be accessed by another object in a domain.
4. Query Processor 140, that processes a user query and generates results.
5. Object Database 150, that stores all objects.
6. Result Delivery and Feedback User Interface 160, an interface through which a registered or un-registered user can access the results.

In OS3 an object may be executable if it contains or is connected to a program or service that when the object is accessed the program or service is executed. In addition, a domain can include documents, other domains and users. The domains can be structured as a domain hierarchy, which means a domain can be created within a domain. The root(s) of the domain hierarchy is determined by the system administrator. Each domain is identified by a sequence of domains in the domain hierarchy that connects a/the root to the domain called an (absolute) path name of the domain. The sequence of domains may be separated by slashes (i.e., domain-name/domain-name/domain-name/ . . . ) or some other symbols depending on the implementation.

A document or user created in a domain is accessed by the (absolute or relative) pathname followed by the name of the document or user. Each user account in OS3 can be a domain.

Each domain is further characterized by its accessibility to and its relationships with other objects. A user, once logged into an account, can navigate to any domain in the domain hierarchy, and use a relative path name (i.e., a sequence of domains in the domain hierarchy that connects the current domain and the target domain) to access a domain.

In one embodiment of OS3 each user account is a root domain and each existing website (e.g., www.sample.com) is a root domain. For example, if user abc created a domain g1 within his/her account and created a domain g13 within g1, the absolute path name for g1 is abc/g1, and the absolute path name for g13 is abc/g1/g13. After the user abc logs in, the user can use the relative domain name 1/g13 to reference the domain g13.

In another embodiment of OS3 each user account is a domain of a root domain called “users.” If user abc created a domain g1 within his/her account and created a domain g13 within g1, the absolute path name for g1 is users/abc/g1, and the absolute path name for g13 is users/abc/g1/g13.

The Object Management Module can be accessed by a user to create an object within a domain. One embodiment of the Object Management User Interface is shown in FIG. 2. At a block 210 it prompts the user to specify the name of the domain under which the object (i.e., a domain, document or user) is created. At a block 220 it checks if the user is allowed to create the object within the domain and, if so, at a block 230 it prompts the user to specify the name of the object. At a block 240 the user specifies the accessibility of the object.

One embodiment of domain accessibility is defined by a combination of one or more access rights: (rp) read by other users, (wp) write by other users, (rwp) both read and write by other users, (ru) read by the user only, (wu) write by the user only, (rwu) both read and write by the user only, (rf) read by the members of the domain only, (wf) write by the members of the domain only, (rwf) both read and written by the members of the domain only, etc.

One embodiment of document accessibility is defined as a combination of one or more access rights: (drp) read by other users, (dwp) write by other users, (drwp) both read and write by other users, (dru) read by the user only, (dwu) write by the user only, (drwu) both read and write by the user only, (drf) read by the members of the domain only, (dwf) write by the members of the domain only, (drwf) both read and write by the members of the domain only, etc.

The Access Control Module determines the accessibility of an object (the first object) by another object (the second object) within a domain. The accessibility is determined by a function that considers the accessibility of the two objects and the relationships among the three objects (including the domain).

Assuming the first object is a document and the second object is a user, one embodiment of the function is:

1. If the domain belongs to the user and the domain is defined to be shared, the document can be accessed by all members of the domain.

2. If the domain belongs to the user and the domain is defined to be public, the document can be accessed by all users.

3. If the domain belongs to the user and the domain is defined to be private, the document can be seen by the user only.

4. If the domain belongs to another user, is defined to be shared and the user is a member of that domain, the document can be seen by all members of that domain.

5. If the domain belongs to another user, is defined to be shared and the user is not a member of that domain, the document can be seen by the user only.

6. If the domain belongs to another user, is defined to be public and the user is a member of that domain, the document can be seen by all users.

7. If the domain belongs to another user, is defined to be public and the user is not a member of that domain, the document can be seen by the user only.

8. If the domain belongs to another user and is defined to be private, the document can be seen by the user only.

9. If the domain is a public domain, the document can be seen by all users.

In OS3, each document or collection of documents referenced by an existing URL (Universal Resource Locator) or pathname is considered a domain and each document therein is considered a document.

A registered or unregistered user of OS3 can submit a query. The result of a query may contain an executable object that contains or connects to a program or service so when the object is accessed by an authorized object the corresponding program or service is executed.

A query can be submitted within a target domain or without a target domain, which implies the search should be performed in all domains. One embodiment of the search process of OS3 is shown in FIG. 3. Given a query from a user on a targeted domain, if the user is a registered user the Query Processor first checks if the query can match any existing query stored in the user's PrRDB for the domain at a block 310. If so the associated object(s) (i.e., domains, users and documents) will be assigned the highest rank and included in the result at a block 320. Subsequently, the Query Processor checks if the query can match any existing query stored in the associated Domain Recommendation Database (DRDB) at a block 330. If so the associated object(s) will be assigned the next highest rank and included in the result at a block 340. At a block 350, the Query Processor searches all the objects in the target domain that the user is authorized to search that may match the given query and assign a rank to the associated object(s) and include it in the result set of objects at a block 360.

At a block 370 the system delivers and displays the objects in the result set based on the ranks. The user can access any result at a block 380. If the user is a registered user, at a block 390 the system prompts the user to recommend to the PrRDB and the associated DRDB(s) more objects from the results that have not yet been recommended. Finally at a block 391 the system stores all query-object pairs together with any additional information to the PrRDB and the corresponding DRDB(s).

### BRIEF DESCRIPTION OF THE DRAWINGS

FIG. 1 illustrates one embodiment of the OS3 system.

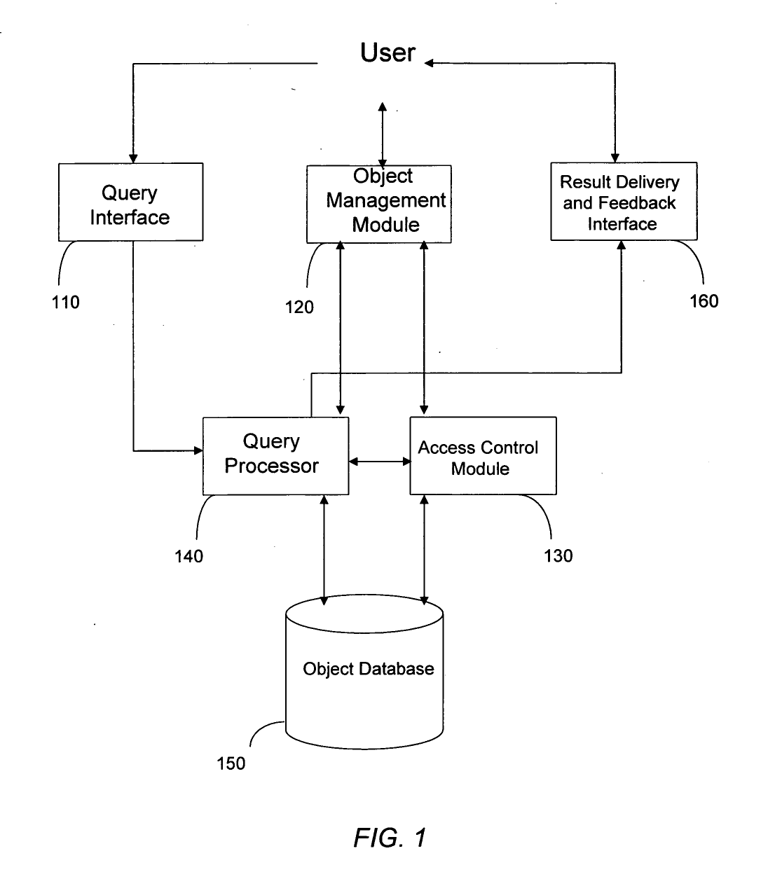

FIG. 2 illustrates one embodiment of an object creation process for a user of OS3.

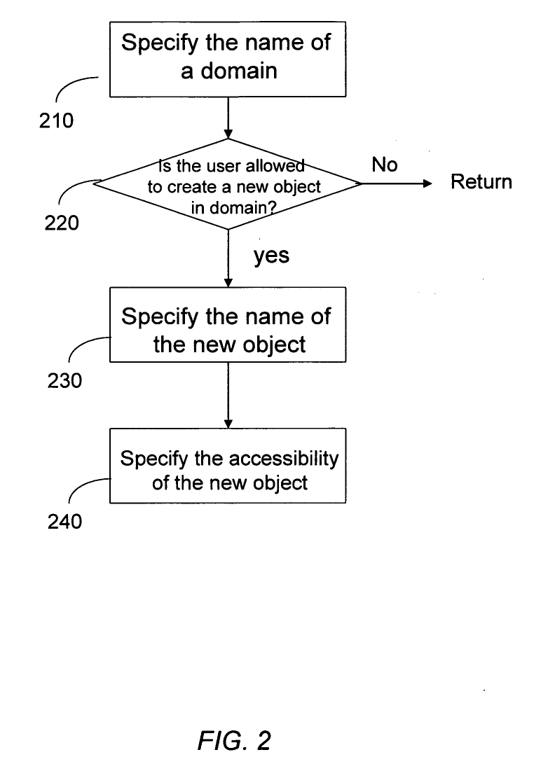

FIG. 3 illustrates one embodiment of the query evaluation process for a user of OS3.

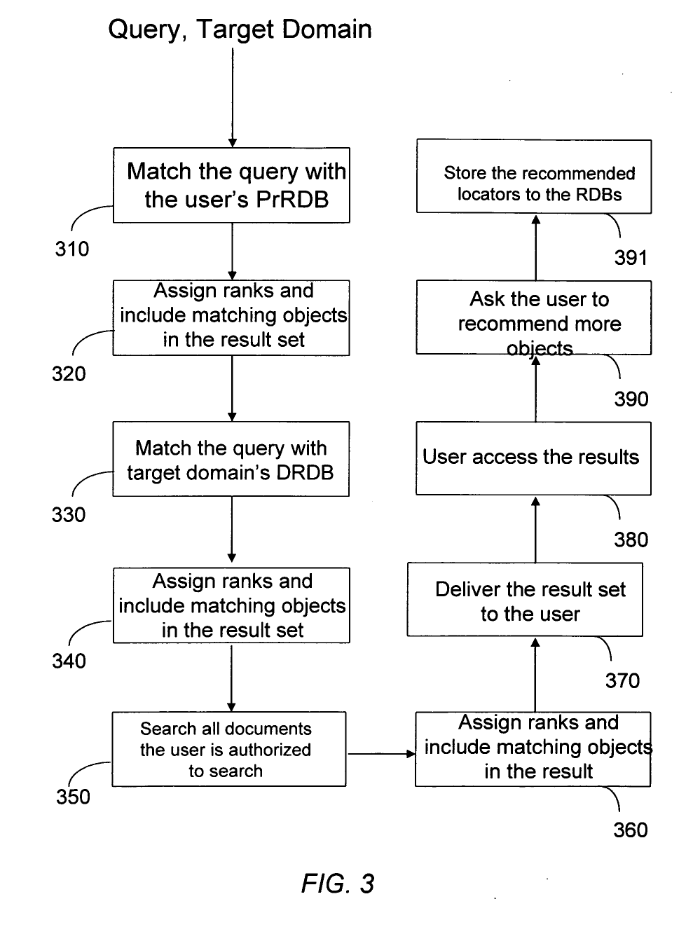

What is claimed is:

1. An object sharing and search system for a multi-user computing environment, the system comprising:
a computer interface that can be connected to a unregistered user that allows the user to create an account and become a user;
a computer interface that can be connected to a user that allows the user to compose a query for a domain;
a computer interface that can be connected to a user that allows the user to create an object in a domain;
a computer program that can decide if and how an object can be accessed by another object in a domain;
a database that stores the objects created;
a query processor that parses each user query and generates the results for the search;
a computer interface that delivers query results and collects user's feedback.

2. The system of claim 1, further comprising a personal recommendation database for each user that stores the query-object pairs recommended by the user for a domain.

3. The system of claim 1, further comprising a domain recommendation database for each domain that stores the query-object pairs recommended by all users for the domain.

4. A computer-implemented method of creating an object (document, domain or user) by a user in a domain, the method comprising:
Prompt the user to enter the (absolute or relative) path name of a domain in which the object is created;
Prompt the user to specify the type of the object to be created;
Check if the user is allowed to create an object of the specified type in the domain specified; if not return with an error;
Prompt the user to specify the name of the new object;
Prompt the user to specify additional information for the new object:
If the new object is a user, a password and one or more his/her roles;
If the new object is an executable object, its parameter(s) if any;
Prompt the user to specify how the new object can be accessed based on its type (including read, write, search, browse, invite, execute, etc. or a combination of the above) by other objects (including the user, members of the domain, members of another domain, all users, general public including unregistered users, the domain, another domain, other documents in the domain, documents in other domains, etc.)

5. The method of claim 4, further comprising prompting the user to annotate the new object with one or more queries in natural language, structured natural language or a set of keywords.

6. The method of claim 4, further comprising that one or more super-users are created by the system initially.

7. The method of claim 4, further comprising prompting the user to specify the additional relationship between the new object and another object or other objects depending on its type.

8. The method of claim 4, further comprising that a member of a domain may automatically become a member of the domain's parent domain recursively.

9. The method of claim 4, further comprising that any collection of documents (including web and desktop documents) referenced by an existing URL (Universal Resource Locator) on the Internet or a local pathname on a computer is a domain automatically, and any document referenced that way is a document automatically.

10. The method of claim 4, further comprising that an executable object may contain or connect to a program or service that can be run when the object is accessed by an authorized object, and the program or service may generate one or more new objects.

11. A computer-implemented method of determining if and how an object may be accessed by another object in a domain, the method comprising:
Obtain the accessibility of the first object;
Obtain the accessibility of the second object;
Obtain the accessibility of the domain;
Obtain the relationship between the two objects (e.g., owner of a domain, member of a domain, user but not member of a domain, user connected with the owner in another domain, etc.);
Obtain the relationship between the two objects and the domain;
Compute if and how the first object may be accessed by the second object in the domain (e.g., read, write, execute) based on a function considering the above factors.

12. A computer-implemented method of generating the results for a query from a registered or unregistered user on the objects in a domain, the method comprising:
Prompt the user to enter a query in natural language, structured natural language, or a set of keywords;
Prompt the user to specify a target domain for the query;
Parse the query;
If a target domain is specified,
Search for executable objects in the target domain that the user is authorized to execute that may match the query;
Otherwise,
Search for executable objects in all domains that the user is authorized to execute that may match the query;
For each executable object found:
if no target domain is specified, parse the query and identify all objects in all domains that the user is authorized to access that are needed as parameters to execute the object and assign a rank and include the executable object in the set of results;
if a target domain is specified, parse the query and identify all objects in the target domain that the user is authorized to access that are needed to as parameters to execute the object and assign a rank and include the executable object in the set of results;
If no executable object can be found and a target domain is specified,
Search for other objects in the target domain that the user is authorized to search that may match the query;
If no executable object can be found and a target domain is not specified,
Search for other objects in all domains that the user is authorized to search that may match the query;
Deliver and display the set of results based on the ranks.

13. The method of claim 12, further comprising that when an executable object is included in the set of results and it is accessed by the user, the corresponding program or service is executed.

14. The method of claim 12, further comprising the existence of one executable object that is connected to a service or program that takes the query and searches the object database based on the query and returns a set of results.

15. The method of claim 12, further comprising that the user is prompted to save all or some of the objects in the result set as a new domain.

16. The method of claim 12, further comprising that searching a personal recommendation database of a registered user any stored query for the target domain that may match the given query and assign the highest rank to the associated object(s) and include it in the result set of objects.

17. The method of claim 12, further comprising that, before searching all the objects in the target domain, searching the domain recommendation database of the target domain any stored query that may match the given query and assign a higher rank to the associated object(s) and include it in the result set of objects.

18. The method of claim 12, further comprising that, after the results are delivered, prompting a registered user to recommend one or more objects based on the query and target domain to the corresponding personal and domain recommendation databases, and storing each (query, object) pair together with any addition information in the corresponding recommendation databases.

19. The method of claim 12, further comprising that, after the results are delivered, prompting a registered user to annotate an object in the result with one or more queries in natural language, structured natural language or a set of keywords.
